(19) United States
(12) Patent Application Publication
(10) Pub. No.: US 2026/0153014 A1
(43) Pub. Date: Jun. 4, 2026

(54) SWELLABLE ELASTOMER SPONGE FOR SAND MANAGEMENT

(71) Applicant: Schlumberger Technology Corporation, Sugar Land, TX (US)

(72) Inventors: Xiaohong REN, Rosharon, TX (US); Jason HOLZMUELLER, Lawrence, KS (US); Scott MALONE, Houston, TX (US); Jushik YUN, Rosharon, TX (US); Luke MACFARLAN, Lawrence, KS (US)

(21) Appl. No.: 18/704,568

(22) PCT Filed: Jan. 10, 2023
(86) PCT No.: PCT/US2023/010451

§ 371 Date: Apr. 25, 2024

Related U.S. Application Data
(60) Provisional application No. 63/266,650, filed on Jan. 11, 2022.

(51) Int. Cl. C09K 8/575; C09K 8/57; E21B 43/08

(52) U.S. Cl. CPC C09K 8/5753; C09K 8/572; E21B 43/082

(57) ABSTRACT

An elastomer foam swellable in the presence of a wellbore fluid. The elastomer foam may include an elastomer, a plurality of smart fillers dispersed within the elastomer, at least one chemical foaming agent, and a curing activator. When exposed to the wellbore fluid, the elastomer foam may increase in volume by at least about 100% and a permeability of the elastomer foam increases from a range of about 1 Darcy to about 70 to a range of about 5 Darcy to about 100 Darcy.

### CROSS-REFERENCE TO RELATED APPLICATIONS

This application claims the benefit of U.S. Provisional Application No. 63/266,650 entitled “Swellable Elastomer Sponge for Sand Management,” filed Jan. 11, 2022, the disclosure of which is incorporated herein by reference in its entirety.

### BACKGROUND

In many hydrocarbon wells, inflowing fluid passes through a sand screen which filters out particulates from the inflowing oil or gas. The sand screen prevents sand from entering the wellbore and reduces damage that may occur by erosion. Conventionally, sand screens are made with a metallic mesh material. Once the sand screen is placed into the wellbore, gravel packs are pumped to fill the annulus between the screen and the formation.

In other instances, some metallic sand screens are expandable and are expanded downhole after placement in the wellbore. The result is a reduction in the annulus between the screen and the formation. The expandable screens in many instances have a limited expansion ratio, and the ability of the expandable screen to conform to borehole irregularities may not be satisfactory. Further, the ability of the expandable sand screen to resist borehole collapse may be reduced. Conventional sand screens are rated to resist greater external pressure than expandable sand screens. Expandable sand screens resist less external pressure because of plastic deformation experienced by their metallic components.

Recently, self-conformable polymer screens have been developed by using thermoplastic urethane (TPU) and implementing a shape memory concept. The polymeric screen has an open cell structure, which has been compressed. The polymeric screen is then placed into a wellbore and expanded by controlling the glass transition temperature of the polymeric material by utilizing an activation fluid, such as acetyl acetone, for example. The activation fluid is difficult to handle at the well site because the flash point of the activation fluid is relatively low, and a special formulation of the fluid is required. Once in the borehole, the polymeric TPU foam material softens and tries to return to its original expanded shape. The expansion outer diameter was designed to be higher than the borehole internal diameter, resulting in the TPU foam conforming to the entire length of an even irregularly shaped, e.g., open hole, borehole, which can circumvent the need to pump gravel slurry in a gravel packing operation. However, one of the disadvantages of the foam material used in these sand screens is the weak mechanical properties of these foams when expanded. The application is limited by the pressure and temperature rating. If an expanded foam fails during a downhole operation, well control may be lost. Further, screen collapse under wellbore pressure may lead to a loss of permeability and a stuck completion string in the wellbore, which may be difficult to repair or change.

### SUMMARY

An elastomer foam swellable in the presence of a wellbore fluid according to one or more embodiments of the present disclosure includes an elastomer, a plurality of smart fillers dispersed within the elastomer, at least one chemical foaming agent, and a curing activator. When exposed to the wellbore fluid, the elastomer foam increases in volume by at least about 100% and a permeability of the elastomer foam increases from a range of about 1 Darcy to about 70 to a range of about 5 Darcy to about 100 Darcy.

A sand screen for use with wellbore fluids and positionable within a well extending through a formation according to one or more embodiments of the present disclosure includes a base pipe and a filter comprising an elastomer foam swellable in the presence of the wellbore fluid. The elastomer foam includes an elastomer, a plurality of smart fillers dispersed within the elastomer, at least one chemical foaming agent, and a curing activator. When exposed to the wellbore fluid, the elastomer foam increases in volume by at least about 100% and a permeability of the elastomer foam increases to a permeability that is about equivalent to or greater than a permeability of the surrounding formation.

A method of making an elastomer foam swellable in the presence of a wellbore fluid according to one or more embodiments of the present disclosure includes dispersing a plurality of smart fillers within the elastomer. The method also includes incorporating at least one chemical foaming agent into the elastomer. The method further includes incorporating at least one curing activator into the elastomer. The method also includes initiating a foaming reaction within the elastomer using the at least one chemical foaming agent. The method further includes initiating a curing reaction within the elastomer. The steps of initiating the foaming reaction and initiating the curing reaction create an open cell structure within the elastomer.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a sectional view of a sand screen positioned in a wellbore according to one or more embodiments of the present disclosure;

FIG. 2 shows a method of making a swellable elastomer foam according to one or more embodiments of the present disclosure;

FIG. 3 shows a swellable elastomer foam according to one or more embodiments of the present disclosure;

FIG. 4 shows closed cell swellable elastomer according to one or more embodiments of the present disclosure; and

FIG. 5 is a graph showing the increase in volume of a swelled elastomer foam according to one or more embodiments of the present disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

In the specification and appended claims: the terms “up” and “down,” “upper” and “lower,” “upwardly” and “downwardly,” “upstream” and “downstream,” “uphole” and “downhole,” “above” and “below,” and other like terms indicating relative positions above or below a given point or element are used in this description to more clearly describe some embodiments of the disclosure.

The present disclosure generally relates to making and using an elastomer composite for sand control applications. More specifically, one or more embodiments of the present disclosure relate to a swellable elastomer foam that is able to expand once deployed downhole to conform to an irregularly shaped wellbore for sand control operations. Without the need for additional activation fluids, the swellable elastomer foam according to one or more embodiments of the present disclosure is much safer than conventional TPU materials. Moreover, the swellable elastomer foam according to one or more embodiments of the present disclosure also provides excellent thermal stability allowing it to be used at temperatures above 120° C. for long-term applications. In contrast, conventional TPU materials are only operable up to 85° C. As further described below, the swellable elastomer foam according to one or more embodiments of the present disclosure exhibits permeability, robustness, and an expansion ratio that are favorable for sand control operations.

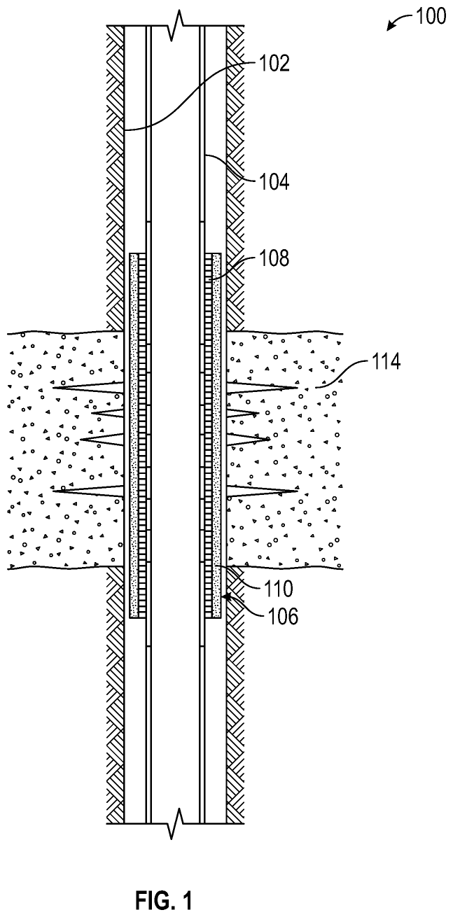

Referring now to FIG. 1, FIG. 1 is a sectional view of a sand screen positioned in a wellbore according to one or more embodiments of the present disclosure is shown. Specifically, the wellbore 100 includes an open bore hole 102, a production tubing string 104, which may be a base pipe according to one or more embodiments, and a sand screen 106. While wellbore 100 is illustrated as being a substantially vertical, uncased well, it should be recognized that the subject disclosure is equally applicable for use in cased wellbores as well as in horizontal and/or inclined wellbores. The sand screen 106 includes a filter member 108 and a compliant material, such as the swellable elastomer foam 10 according to one or more embodiments of the present disclosure. The sand screen 106 is shown positioned in the wellbore 100 adjacent a producing formation 114. According to one or more embodiments of the present disclosure, the swellable elastomer foam 10, which is a highly permeable open cell foam, as described in more detail below, may be the only filtration agent without the use of any filter member 108. In one or more embodiments of the present disclosure, the filter member 108 can be configured for structural support of the swellable elastomer foam 10.

Still referring to FIG. 1, in a well completion method according to one or more embodiments of the present disclosure, at least one base pipe 104 may be covered with the swellable elastomer foam 10 according to one or more embodiments of the present disclosure. The swellable elastomer foam 10 covering the base pipe 104 may be covered with a retainer before running the base pipe 104 to a location in the wellbore 100. Upon exposure to a condition in the wellbore 100, the retainer may degrade and expose the swellable elastomer foam to the wellbore fluids. In one or more embodiments, the smart fillers swell and/or stiffen the swellable elastomer foam 10 during expansion. As the swellable elastomer foam 10 expands into and fills the annulus, the swellable elastomer foam 10 conforms to a wall of the wellbore 100. Because the swellable elastomer foam 10 is able to conform to the wellbore 100 wall in this way and has a permeability that is about equivalent to or greater than the permeability of the surrounding formation, the swellable elastomer foam 10 is able to allow formation fluids into the base pipe 104 while filter debris including sand from fluids from the producing formation 114. After the downhole operation is complete, the swellable elastomer foam 10 may be detached from the base pipe 104, and the base pipe 104 may be lifted out of the wellbore 100.

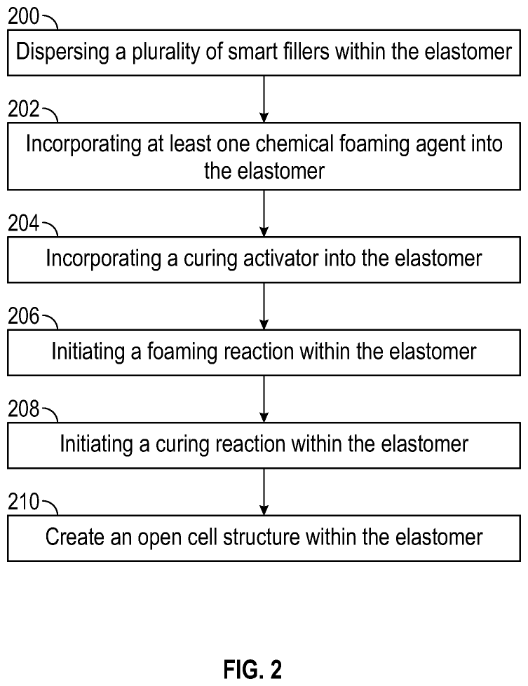

Referring now to FIG. 2, FIG. 2 shows a method of making a swellable elastomer foam according to one or more embodiments of the present disclosure is shown. Specifically, in step 200 of the method of making a swellable elastomer foam according to one or more embodiments of the present disclosure, a plurality of smart fillers are dispersed within an elastomer. According to one or more embodiments of the present disclosure, the elastomer include, but is not limited to, natural rubber, Hydrongenated Acrylonitrile Butadiene (“HNBR”), or other similar elastomers. The composition of the elastomer may include a linear or branched polymer having residual ethylenic unsaturation with an ethylenically unsaturated organic monomer, for example, but not limited to, terpolymers of ethylene-propylene-diene monomer. By varying the fundamental characteristics (molecular weight, copolymer composition, % unsaturation) of the linear or branched polymer having residual ethylenic unsaturation, the degree of swelling in hydrocarbon oil may be varied.

Additionally, according to one or more embodiments of the present disclosure, the plurality of smart fillers may include a swellable smart filler, for example, which increases in volume when deployed into well fluid or brine. The swellable filler may include at least one of a super absorbent polymer (SAP), and MgO, for example. The elastomer may also include a zwitterionic polymer or copolymer of zwitterionic monomers, allowing production of a cross-linkable elastomer that swells in high salinity brines as well as in hydrocarbon oils.

Specifically, SAP is a type of hydrophilic polymer (cross-linked hydrogel) having water-absorbing capacity from 100 g/g up to 2000 g/g, in which the absorbed water is scarcely removable even under pressure because the water molecules are held tightly in the network by hydrogen bonding. SAP may include a sodium salt of crosslinked polyacrylic acid such as LiquiBlock HS fines, for example, which are used to increase water uptake of the polymer and mainly contribute to water swelling of the swellable elastomer foam. These polymers may control the final state of swell of the swellable elastomer foam according to one or more embodiments of the present disclosure. Indeed, using a cross-linked polymer like SAP will facilitate the passage of water through the three-dimensional network of the structure, while retaining the polymer structure, which can force the structure to swell.

To control the rate of swell of the swellable elastomer foam due to swellable smart fillers, salt may be used to balance the osmotic pressure differential that might exist in a downhole condition. If the osmotic pressure is too high, the rate of swell will be excessive, and the structure of the elastomer may be damaged. In one or more embodiments of the present disclosure, micro-sized fine salt may be used in the formulation, and the salt may also act as a secondary swelling agent to increase the water uptake by the swellable elastomer foam.

As previously described, MgO may also be used as a swellable filler in one or more embodiments of the present disclosure. For example, high temperature expanding MgO additives that reacts with water may be used to form a crosslinked micro domain to stiffen the swellable elastomer foam according to one or more embodiments of the present disclosure. The reaction rate depends on the pH, temperature, pressure, and the elastomer of the swellable elastomer foam. In particular, MgO may be important for the swellable elastomer foam according to one or more embodiments of the present disclosure to increase the hardness of the elastomer with time so that the sand screen does not easily deform from differential pressure that may build up across the filter membrane during operation.

The SAPs that may be used in accordance with one or more embodiments of the present disclosure include cross-linked forms of polyacrylate (acrylic acid and acrylamide), polyvinyl alcohol, poly(ethylene oxide), starch-acrylate copolymer, carboxymethyl cellulose, and other hydrophilic swellable polymers. As understood by those having skill in the art, the degree of swelling and the swelling rate of SAPs depend on the type of cross-linked polymer, the conditions of the water with respect to pH, salinity, temperature, and pressure, the duration of immersion in a solution, and the design of the samples.

In addition to the swellable smart filler, the plurality of smart fillers may include at least one reinforcing smart filler according to one or more embodiments of the present also disclosure. Examples of a reinforcing smart filler according to one or more embodiments of the present disclosure include Portland cement, aluminous cement, fly ash, slag cement, MgO, ZnO, Ca(OH)₂, ZnCl₂, MgCl₂, CaCl₂, CaCO₃, Na₂CO₃, and K₂CO₃, for example.

Still referring to FIG. 2, in step 202 of the method of making a swellable elastomer foam according to one or more embodiments of the present disclosure, at least one chemical foaming agent (CFA) may be included into the elastomer. A chemical foaming agent is a chemical that decomposes and releases gases at a temperature above its decomposition temperature. Types of CFAs that may be used in the method according to one or more embodiments of the present disclosure include Azodiacarbonamide (azo), sulfonyl hydrazide (OBSH, TSH, etc.) and sodium bicarbonate, for example. In particular, sodium bicarbonate, an inorganic foaming agent, may advantageously release carbon dioxide during a foaming reaction to facilitate the creation of an open cell foam. Due to its low compatibility with an elastomer matrix, sodium bicarbonate wants to escape from the polymer, leaving behind open and connected pores in the foamed parts, in one or more embodiments of the present disclosure. Moreover, a combination of organic and inorganic CFAs (e.g., sodium bicarbonate and an azo-based organic foaming agent) may be incorporated into the elastomer to act synergistically to create an open porous structure in the method according to one or more embodiments of the present disclosure.

Still referring to FIG. 2, in step 204 of the method of making a swellable elastomer foam according to one or more embodiments of the present disclosure, a curing activator may be incorporated into the elastomer. As further described below, two ways of vulcanizing or curing elastomer compound according to one or more embodiments of the present disclosure include sulfur curing and peroxide curing, for example. The curing activator activates either sulfur curing or peroxide curing and decomposition of the CFA with respect to the curing and foaming reactions of the method according to one or more embodiments of the present disclosure, as further described below.

Still referring to FIG. 2, in steps 206 and 208 of the method of making a swellable elastomer foam according to one or more embodiments of the present disclosure, foaming and curing reactions may be initiated within the elastomer. In the method according to one or more embodiments of the present disclosure, steps 206 and 208 may be balanced such that the curing reaction trails behind the foaming reaction in order to create an open cell structure within the elastomer (S22). Indeed, in order to create an open cell sponge, it is essential to balance the reaction between curing and blowing (i.e., foaming).

In an example for making a swellable elastomer foam for a swellable sand screen according to one or more embodiments of the present disclosure, about 5 -15 parts per hundred of rubber (PHR) of sodium bicarbonate is incorporated with about 1-15 PHR of azo-based organic foaming agent in the presence of 0.5-1.5 PHR curing activator such as Rhenogran Geniplex-70 in a sulfur cured formulation. Specifically, Geniplex-70 is a zinc dicyanato diamine based inorganic isocyanate that can be used to activate sulfur curing and decomposition of an azo foaming agent during the foaming and curing reaction steps (206, 208) of the method according to one or more embodiments of the present disclosure.

To initiate sulfur curing, elemental sulfur or sulfur donors are needed. In one or more embodiments of the present disclosure, a sulfur donor is selected for use over elemental sulfur insofar as sulfur donors react to contribute primarily mono and disulphidic bridges that have much higher heat resistance to a polysulphidic bridge formed by elemental sulfur. According to one or more embodiments of the present disclosure, Rhenogran CLD-80, a sulfur donor that does not generate carcinogenic N-nitrosamines during vulcanization, is used for example. Moreover, when Rhenogran CLD-80 is used as the sulfur donor, the resulting vulcanizates do not show any blooming. In a method according to one or more embodiments of the present disclosure, to control the rate of curing and the state of curing, primary and secondary accelerators such as thiurams (tetramethylthiuram disulfide (TMTD), tetraethylthiuram disulfide (TETD), etc.), thiazoles (zinc salt of 2-mercaptobenzothiazole (ZMBT), 2-mercaptobenzothiazole (MBT), 2,2′-benzothiazolyl disulfide (MBTS), etc.) or sulfonamides (carboxybenzenesulfonamide (CBS), N-tert-butyl-benzothiazole sulfonamide (TBBS), N,N-Dicyclohexyl-2-benzothiazolsulfene amide (DCBS), etc.) may be used to balance the reaction speed (scorch time) and curing time. In this example, secondary accelerators such as MBTS may be used to provide scorch resistance and to delay the reaction of curing to slightly trail behind the reaction of blowing, which facilitates creation of the open cell structure within the elastomer (S22). According to one or more embodiments of the present disclosure, the curing reaction may trail behind the blowing or foaming reaction by about 15 minutes, 10 minutes, 5 minutes, 2 minutes, 1 minute, 30 seconds, 20 seconds, 10 seconds, 5 seconds, 3 seconds, 2 seconds, or 1 second, for example.

Instead of using a curing activator that includes sulfur for sulfur curing as previously described with respect to steps 206 and 208 in a method according to one or more embodiments of the present disclosure, a curing activator that includes peroxide for peroxide curing may be used in a method according to one or more embodiments of the present disclosure. For example, peroxides such as, but not limited to, dicumyl peroxide, 2,5-dimethyl-2,5-di(t-butylperoxy)-hexane, a,a′-bis(t-butylperoxy)-diisopropylbenzene, 2,5-dimethyl-2,5-di(t-butylperoxy)-3-hexyne, or any combination thereof may be used as the curing activator to facilitate peroxide curing according to one or more embodiments of the present disclosure. In one or more embodiments, a peroxide co-agent, such as, but not limited to, trifunctional (meth)acrylate ester, N,N′-m-phenylene dimaleimide, poly(butadiene) diacrylate, or any combination thereof may be used to accelerate the rate of cur and/or the final state of cure. Moreover, swellable elastomer foams cured by peroxide and sulfur according to one or more embodiments of the present disclosure may have very different properties including modulus and elongation at break. For example, in one or more embodiments of the present disclosure, the sulfur cured swellable elastomer foam may have a much higher elongation at break than a similarly processed peroxide cured swellable elastomer foam due in part to the short and more flexible disulphidic bond that forms during sulfur curing in contrast with the short and rigid C—C bond that forms during peroxide curing. The more flexible and soft nature of S—S bonds of the sulfur cured swellable elastomer foam may allow gases to escape easier than the more rigid and short C—C bonds of the peroxide cured swellable elastomer foam. As such, the sulfur cured swellable elastomer foam according to one or more embodiments of the present disclosure may have a more porous open cell structure after the curing reaction is completed.

In addition to the above, the swellable elastomer foam according to one or more embodiments of the present disclosure may include an antioxidant, which may improve the ageing properties of the rubber. While a downhole environment may be depleted of free oxygen, dissolved oxygen could still exist and attack the polymer sand screen, causing degradation, oxidation, and embrittlement of the material at an elevated temperature. Types of antioxidants that may be used in the swellable elastomer foam according to one or more embodiments of the present disclosure include an amine and/or imidazole based compound such as VANOX® CDPA and ZMTI, which may work synergistically to improve the overall heat aging properties of the swellable elastomer foam.

In addition to the above, the swellable elastomer foam according to one or more embodiments of the present disclosure may include a process aid, which may be an oil or dry liquid concentrate compounded into the swellable elastomer foam to improve processability by lowering the viscosity of the swellable elastomer foam. Types of process aids that are compatible with nitrile based compounds, such as the swellable elastomer foam according to one or more embodiments of the present disclosure, include Paraplex G-25, Plasthall TOTM, Plasthall P-7092, Hallstar Dioplex 100, and Paraplex G-57, for example. Additionally, the swellable elastomer foam may incorporate some degradable elements (fibers or particles) that will intentionally dissolve as the elastomer foam swells, creating further channels for fluid permeation to occur.

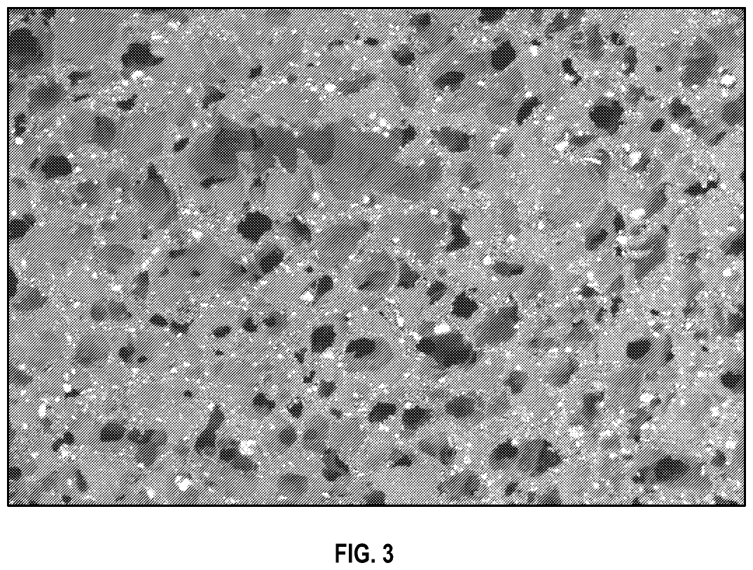

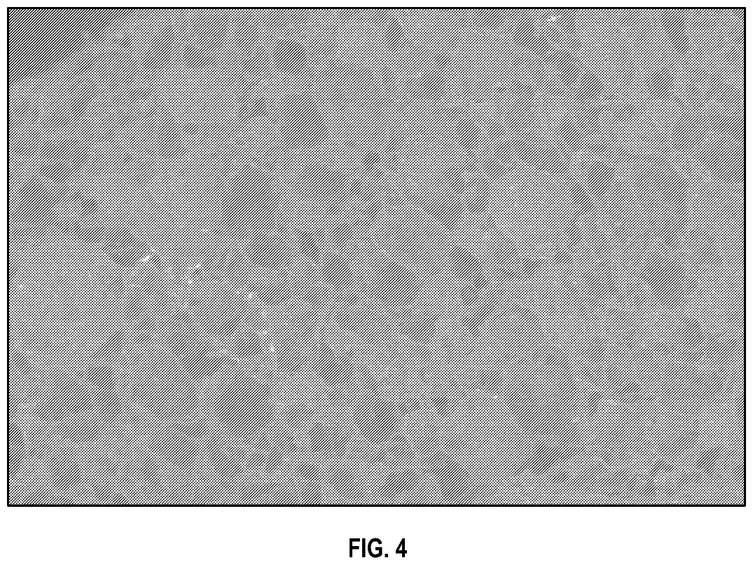

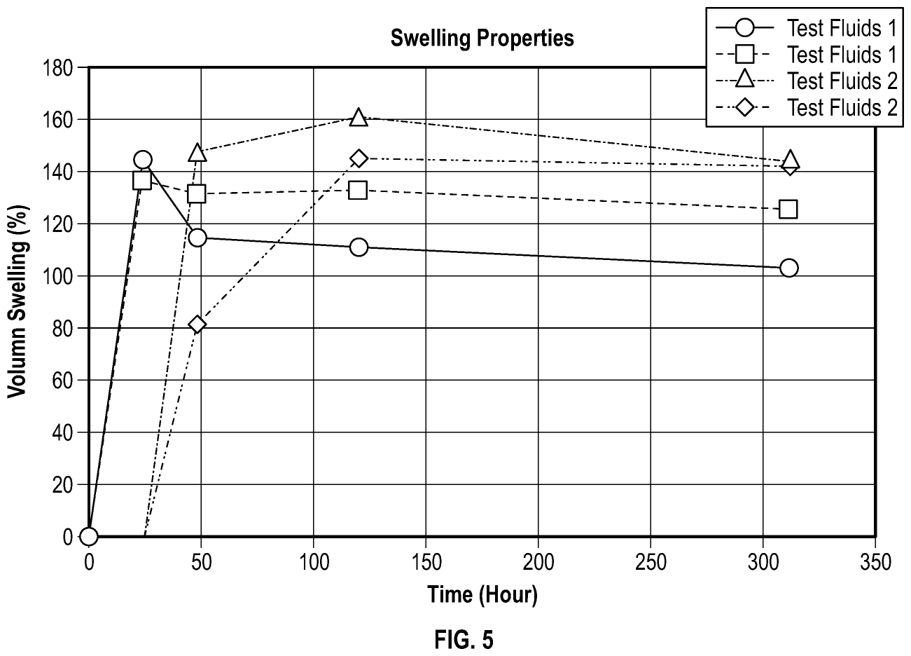

Referring now to FIG. 3, FIG. 3 shows a swellable elastomer foam sample that includes a plurality of smart fillers such as swellable smart filters, at least one chemical foaming agent, and a curing activator, for example. This swellable elastomer foam has a permeability of about 1 Darcy to about 70 Darcy prior to swelling due to the presence of a wellbore fluid, such as, but not limited to, oil. In contrast, the closed cell swellable elastomer shown in FIG. 4 has a permeability of about 0.12 Darcy. As shown in FIG. 5, once the swellable elastomer foam is exposed to a wellbore fluid, the swellable elastomer foam swells, increasing in volume at least about 100%. This increase in volume of the swellable elastomer foam also increases the permeability of the swellable elastomer foam, resulting in a permeability of about 5 Darcy to about 100 Darcy. In other embodiments, the permeability of the swellable elastomer foam may increase as the volume of the swellable elastomer foam increases to a permeability that is about equivalent to or greater than the permeability of the surrounding formation, which may be less than 5 Darcy or greater than 100 Darcy. As discussed above, the amount of swelling and the permeability of the swellable elastomer foam may be adjusted by varying the composition of the swellable elastomer foam.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. An elastomer foam swellable in the presence of a wellbore fluid, the elastomer foam comprising:
an elastomer;
a plurality of smart fillers dispersed within the elastomer;
at least one chemical foaming agent;
a curing activator; and
wherein, when exposed to the wellbore fluid, the elastomer foam increases in volume by at least about 100% and a permeability of the elastomer foam increases from a range of about 1 Darcy to about 70 to a range of about 5 Darcy to about 100 Darcy.

2. The elastomer foam of claim 1, wherein the plurality of smart fillers comprises at least one selected from the group consisting of: a swellable filler; and a reinforcing filler.

3. The elastomer foam of claim 2, wherein the swellable filler comprises at least one selected from the group consisting of: a super absorbent polymer (SAP); and MgO.

4. The elastomer foam of claim 2, wherein the reinforcing filler comprises at least one selected from the group consisting of: Portland cement, aluminous cement, fly ash, slag cement, MgO, ZnO, Ca(OH)₂, ZnCl₂, MgCl₂, CaCl₂, CaCO₃, Na₂CO₃, and K₂CO₃.

5. The elastomer foam of claim 1, wherein the at least one chemical foaming agent is at least one selected from the group consisting of: azodiacarbonamide; and sodium bicarbonate.

6. The elastomer foam of claim 1, wherein the curing activator comprises at least one selected from the group consisting of: sulfur; and peroxide.

7. The elastomer foam of claim 1, further comprising degradable elements that dissolve as the elastomer foam swells.

8. A sand screen for use with wellbore fluids and positionable within a well extending through a formation, the sand screen comprising:
a base pipe; and
a filter comprising an elastomer foam swellable in the presence of the wellbore fluid and comprising:
an elastomer;
a plurality of smart fillers dispersed within the elastomer;
at least one chemical foaming agent;
a curing activator; and
wherein, when exposed to the wellbore fluid, the elastomer foam increases in volume by at least about 100% and a permeability of the elastomer foam increases to a permeability that is about equivalent to or greater than a permeability of the surrounding formation.

9. The sand screen of claim 8, wherein the plurality of smart fillers comprises at least one selected from the group consisting of: a swellable filler; and a reinforcing filler.

10. The sand screen of claim 9, wherein the swellable filler comprises at least one selected from the group consisting of: a super absorbent polymer (SAP); and MgO.

11. The sand screen of claim 9, wherein the reinforcing filler comprises at least one selected from the group consisting of: Portland cement, aluminous cement, fly ash, slag cement, MgO, ZnO, Ca(OH)₂, ZnCl₂, MgCl₂, CaCl₂, CaCO₃, Na₂CO₃, and K₂CO₃.

12. The sand screen of claim 8, wherein the at least one chemical foaming agent is at least one selected from the group consisting of: azodiacarbonamide; and sodium bicarbonate.

13. The sand screen of claim 8, wherein the curing activator comprises at least one selected from the group consisting of: sulfur; and peroxide.

14. The sand screen of claim 8, further comprising a degradable retainer covering the elastomer foam.

15. A method of making an elastomer foam swellable in the presence of a wellbore fluid, the method comprising:
dispersing a plurality of smart fillers within the elastomer;
incorporating at least one chemical foaming agent into the elastomer;
incorporating at least one curing activator into the elastomer;
initiating a foaming reaction within the elastomer using the at least one chemical foaming agent;
initiating a curing reaction within the elastomer; and
wherein the steps of initiating the foaming reaction and initiating the curing reaction create an open cell structure within the elastomer.

16. The method of claim 15, wherein the plurality of smart fillers comprises at least one selected from the group consisting of: a swellable filler; and a reinforcing filler.

17. The method of claim 16, wherein the swellable filler comprises at least one selected from the group consisting of: a super absorbent polymer (SAP); and MgO.

18. The method of claim 16, wherein the at least one chemical foaming agent is at least one selected from the group consisting of: azodiacarbonamide; and sodium bicarbonate.

19. The method of claim 16, wherein the step of initiating the curing reaction further comprises using a curing activator comprising at least one selected from the group consisting of: sulfur; and peroxide.

20. The method of claim 16, further comprising balancing the steps of initiating the foaming reaction and initiating the curing reaction such that the curing reaction trails behind the foaming reaction.
